(19) United States
(12) Patent Application Publication
(10) Pub. No.: US 2009/0122918 A1
(43) Pub. Date: May 14, 2009

(54) Methods for Compensating for I/Q Imbalance in OFDM Systems

(75) Inventors: Junqiang Li, Sunnyvale, CA (US); Baoguo Yang, San Jose, CA (US); Yue Chen, Fremont, CA (US)

Correspondence Address: Venture Pacific Law, PC, 5201 Great America Parkway, Suite 270, Santa Clara, CA, 95054, US

(73) Assignee: Augusta Technology, Inc., Santa Clara, CA (US)

(21) Appl. No.: 12/266,534

(22) Filed: Nov. 6, 2008

Related U.S. Application Data
(60) Provisional application No. 60/985,971, filed on Nov. 6, 2007.

(51) Int. Cl. H04L 25/06

(52) U.S. Cl. 375/317

(57) ABSTRACT

The present invention relates to methods for demodulating orthogonal frequency division multiplexing (OFDM) modulated signals. In particular, this invention relates to methods for in-phase (I) and quadrature phase (Q) imbalance compensation in OFDM systems. For example, the present invention relates to methods for calculating an IQ imbalance compensated signal from a received signal, comprising the steps of: removing DC from the received signal; calculating an autocorrelation matrix of IQ signal vector of the received signal; estimating IQ imbalance compensation values, K₁ and K₂, as a function of an amplitude imbalance, g, and a phase imbalance, θ; and calculating an IQ compensated signal as a function of the estimated K₁ and K₂.

### CROSS REFERENCE

This application claims priority from a provisional patent application entitled “Effects of IQ Imbalance and Compensation in DVB-H” filed on Nov. 6, 2007 and having an Application No. 60/985,971. Said application is incorporated herein by reference.

### FIELD OF INVENTION

This invention relates to methods for demodulating orthogonal frequency division multiplexing (OFDM) modulated signals. In particular, this invention relates to methods for in-phase (I) and quadrature phase (Q) imbalance compensation in OFDM systems.

### BACKGROUND

In many communications systems, data is often converted into a passband signal, e.g., centered around a carrier frequency, before transmission. One reason for converting the original signal into a passband signal is that the conversion allows multiple channels of data to be transferred over a single transmission medium, e.g. by using several different carrier signals. A common example is radio broadcasts.

In many systems, the passband signal is first converted to its baseband, i.e. is centered around zero frequency as opposed to the carrier frequency, before further signal processing takes place. The generation of the baseband signal is in many cases done with analog devices before any analog-to-digital (A/D) conversion takes place. The baseband signal normally comprises an in-phase (I) component and a quadrature (Q) component.

The I and Q components of a baseband signal are often processed separately, e.g., in parallel. As part of the process to obtain a baseband signal, the passband signal is copied and multiplied by a cos(2πf_{c}t) signal to generate the I component. The same passband signal is copied and multiplied by a sin(2πf_{c}t) signal to generate the Q component. In principle, the in-phase cos(2πf_{c}t) and quadrature sin(2πf_{c}t) components should have exactly π/2 phase shift and the same amplitude. However, in reality, it is very difficult and costly to achieve a highly accurate π/2 phase shift and equal amplitude using analog devices. Consequently, the resultant in-phase and quadrature components generally have imbalance in amplitude and/or phase (I/Q imbalance), which causes signal quality degradation in the subsequent signal processing by receivers of the signal.

I/Q imbalance is a well-known problem in receiver design of many communication systems, such as in OFDM systems. Therefore, many I/Q imbalance compensation devices are known in the art. Unfortunately some of these devices can be very complex in their design. Complex designs are often harder to implement in hardware, and have higher processing overhead than simple designs.

Therefore, it is desirable to provide methods for I/Q imbalance compensation for the demodulation of an OFDM modulated signal.

### SUMMARY OF INVENTION

An object of this invention is to provide methods for I/Q imbalance compensation in the time domain.

Another object of this invention is to provide methods for I/Q imbalance compensation, where I/Q imbalance can be reduced to within 0.1 dB.

Yet another object of this invention is to provide methods for I/Q imbalance compensation, where pilot information is not needed to compensate for I/Q imbalance.

Briefly, the present invention relates to methods for calculating an I/Q imbalance compensated signal from a received signal, comprising the steps of: removing DC from the received signal; calculating an autocorrelation matrix of I/Q signal vector of the received signal; estimating I/Q imbalance compensation values, K₁ and K₂, as a function of an amplitude imbalance, g, and a phase imbalance, θ; and calculating an I/Q compensated signal as a function of the estimated K₁ and K₂.

An advantage of this invention is that I/Q imbalance compensation is performed in the time domain.

Another advantage of this invention is that I/Q imbalance can be reduced to within 0.1 dB.

Yet another advantage of this invention is that pilot information is not needed to compensate for I/Q imbalance.

### DESCRIPTION OF THE DRAWINGS

The foregoing and other objects, aspects, and advantages of the invention will be better understood from the following detailed description of the preferred embodiment of the invention when taken in conjunction with the accompanying drawings in which:

FIG. 1 illustrates a flow chart for correcting various distortions to a received signal, r(t).

FIG. 2a illustrates a process flow for an embodiment of the present invention for I/Q imbalance compensation

FIG. 2b illustrates a fixed point design for calculating autocorrelation matrix values for a first calibration mode.

FIG. 2c illustrates a fixed point design for estimating I/Q imbalance parameters.

FIG. 2d illustrates a fixed point design for I/Q imbalance compensation based on I/Q imbalance parameters.

FIG. 3 illustrates a Sqrt_appr module.

FIG. 4 illustrates a fixed point design for calculating autocorrelation matrix values for a second calibration mode.

### DETAILED DESCRIPTION OF THE PREFERRED EMBODIMENTS

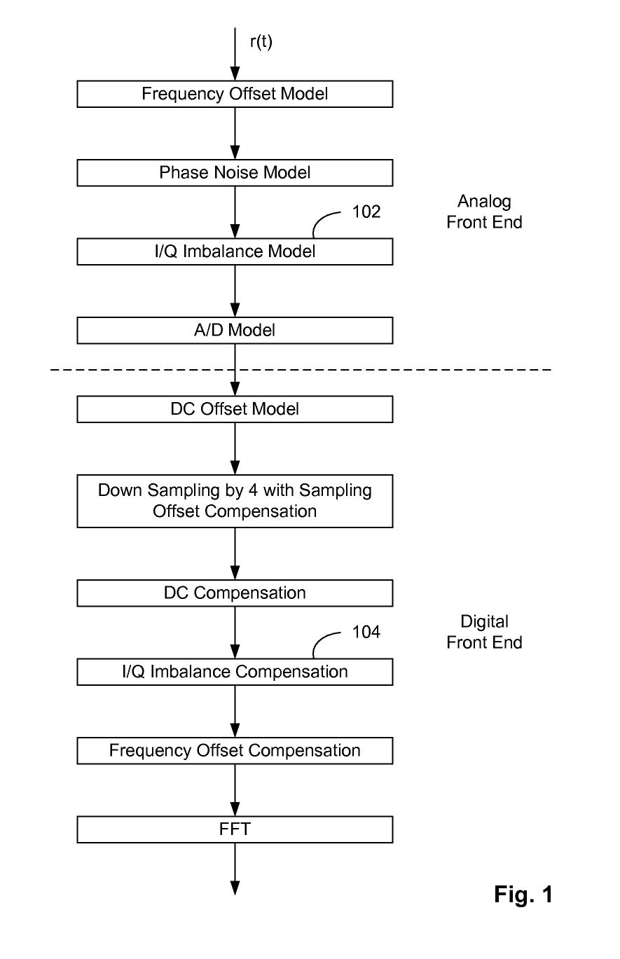

FIG. 1 illustrates a flow chart for correcting various distortions to a received signal, r(t). The various distortions to a received signal can be modeled by a frequency offset model, a phase noise model, and an I/Q imbalance model 102. The received signal can be converted from an analog signal to a digital signal by an A/D model. The digital signal is then modeled by a direct current (DC) offset model.

The digital signal may be down sampled by 4 with a sampling offset compensation. Next, the signal can be adjusted by DC compensation, where DC is estimated and removed. The signal is then adjusted by IQ imbalance compensation 104, and a frequency offset compensation. After compensation, a fast-Fourier transform (FFT) can be applied to the signal to convert the signal from the time domain to the frequency domain. The focus of the present invention is on DC compensation and I/Q imbalance compensation.

### I/Q Imbalance Model

The I/Q imbalance model 102 can be used to model the I/Q imbalance.

The real radio frequency (RF) signal just before a down-conversion can be written as

r(t)=y(t)e^{j+2πf}^{_{c}}^{t}+y*(t)e^{-j2πf}^{_{c}}^{t} (1)

The local oscillator (LO) with I/Q imbalance can be given by

\tilde{x}_{LO}(t)=cos(2πf_{c}t)−jg sin(2πf_{c}t+θ) (2)

where g denotes the amplitude imbalance, f_{c} denotes the carrier frequency, and θ denotes the phase imbalance. Furthermore, we can define the complex I/Q imbalance parameters as

$$\begin{matrix}{K}_{1} = \frac{1 + {ge}^{- j θ}}{2} & ( 3 ) \\ {K}_{2} = \frac{1 - {ge}^{ j θ}}{2} & ( 4 )\end{matrix}$$

The local oscillator with I/Q imbalance, Equation (2), can be rewritten using Equation (3) and Equation (4) as—

\tilde{x}_{LO}(t)=K₁e^{-2πf}^{_{c}}^{t}+K₂e^{2πf}^{_{c}}^{t} (5)

Therefore, the received base band signal with the I/Q imbalance can be given by

Y(t)=LP{r(t)\tilde{x}_{LO}(t)}=K₁y(t)+K₂y*(t) (6)

Also, by considering the I and Q components of Y(t) and y(t),

Y_{I}(t)=^{y}_{I}(t) (7)

Y_{Q}(t)=g Cos(θ)y_{Q}(t)−g sin(θ)y_{I}(t) (8)

And including a frequency offset of,

Δ ω̅t+φ (9)

the I and Q components of Y(t) and y(t), Equation (7) and Equation (8) respectively, can be

Y_{I}(t)=cos(Δ ω̅t+φ)y_{I}(t)+sin(Δ ω̅t+φ)y_{Q}(t) (10)

Y_{Q}(t)=g cos(Δ ω̅t+φ+θ)y_{Q}(t)−g sin(Δ ω̅t+θ+φ)y_{I}(t) (11)

### Time Domain I/Q Imbalance Compensation

Equation (10) and Equation (11) can be rewritten as the following,

$$\begin{matrix}{Z}^{″} = [ \begin{matrix}{Y}_{I} ( t ) \\ {Y}_{Q} ( t )\end{matrix} ] = A ( t ) [ \begin{matrix}{y}_{I} ( t ) \\ {y}_{Q} ( t )\end{matrix} ] = A ( t ) Z \\ where & ( 12 ) \\ A ( t ) = [ \begin{matrix}cos ( △ϖ t + φ ) & sin ( △ ϖ t + φ ) \\ - g sin ( △ϖ t + φ ) & g cos ( △ϖ t + φ + θ )\end{matrix} ] & ( 13 )\end{matrix}$$

Furthermore, the following autocorrelation matrix can be defined,

R_{Z″Z″}_{^{T}}=R_{ZZ}_{^{T}}A(T)A^{T}(t) (14)

where,

$${R}_{{Z}^{″} {Z}^{″ T}} = {σ}_{Z}^{2} [ \begin{matrix}1 & - g sin ( θ ) \\ - g sin ( θ ) & {g}^{2}\end{matrix} ] \qquad ( 15 )$$

Furthermore, the autocorrelation matrix values can be denoted,

R[0]=σ_{Z}² (16)

R[1]=R[2]=−g sin(θ)σ_{Z}² (17)

R[3]=−g²σ_{Z}² (18)

According to Equation (3), Equation (4), and Equation (15), K₁ and K₂ can be estimated according to Equation (6). Thus, an I/Q imbalance compensated signal can be achieved

$$y ( t ) = \frac{{( {( {K}_{1}^{*} ⋆ Y ( t ) )}^{*} - {K}_{2}^{*} ⋆ Y ( t ) )}^{*}}{( {‖ {K}_{1} ‖}^{2} - {‖ {K}_{2} ‖}^{2} )} \qquad ( 19 )$$

where (∥K₁∥²−∥K₂∥²) can be denoted as K12.

### Fixed Point Design

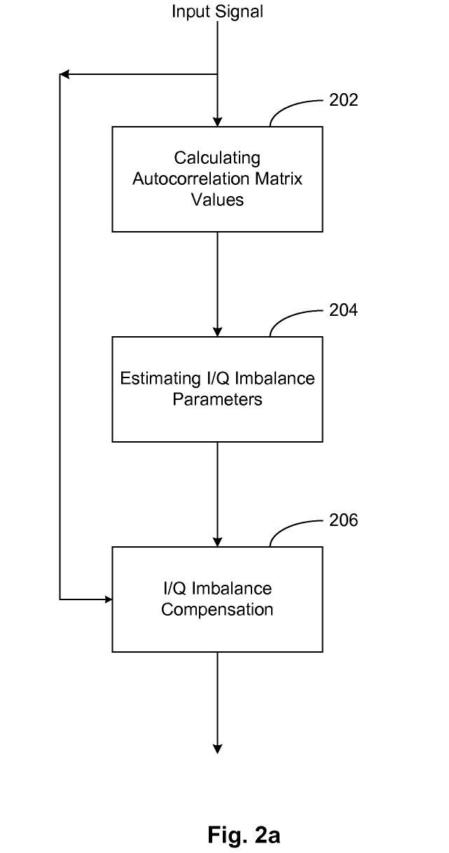

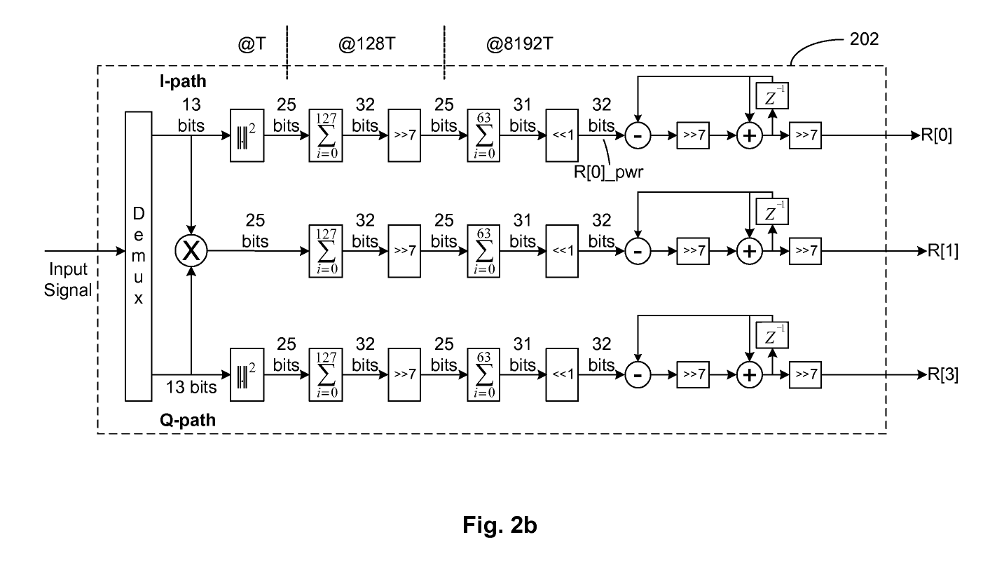

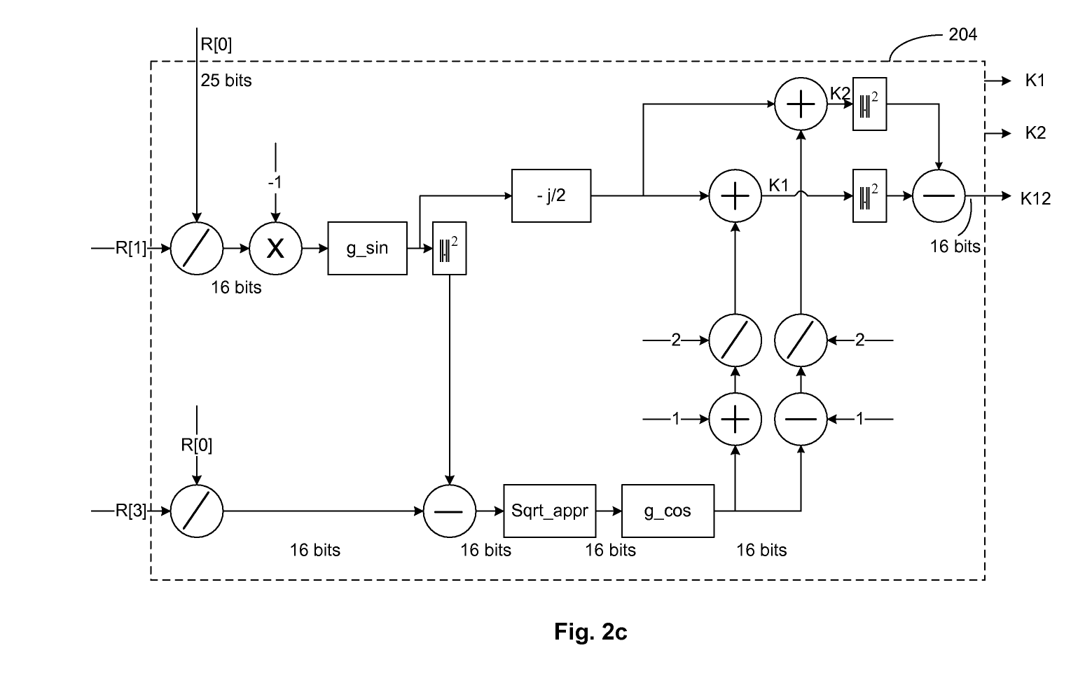

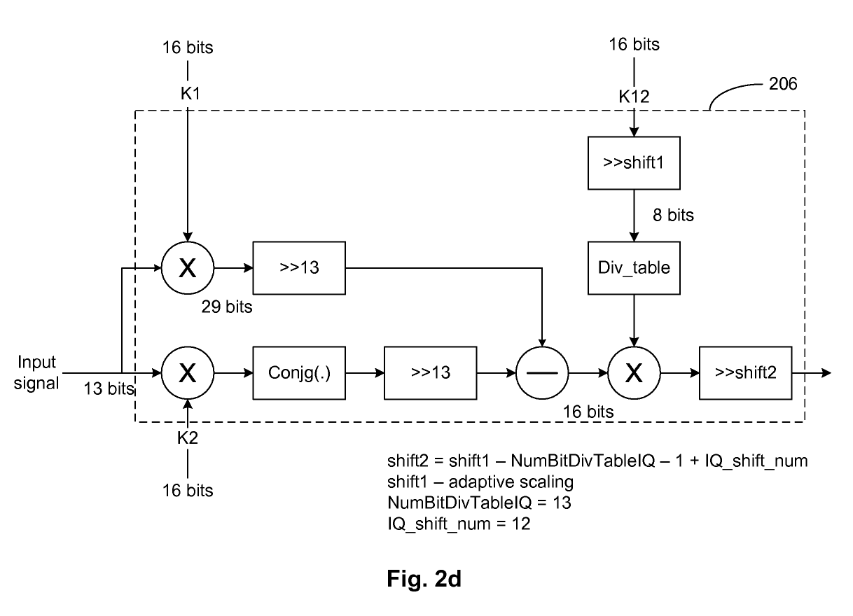

FIG. 2a illustrates a process flow for an embodiment of the present invention for I/Q imbalance compensation. Referring to FIG. 2a, an input signal is demultiplexed to recover an I component and a Q component. The I and Q components are further processed by calculating autocorrelation matrix values, R[0], R[1] and R[3], 202 from Equation (15). The autocorrelation matrix values R[0], R[1], and R[3] can then be used to estimate I/Q imbalance parameters 204, K₁, K₂, and K12. The K₁, K₂, and K12 values are then used by an I/Q imbalance compensation module 206 to correct the I/Q imbalance.

Calibration Mode 1

FIG. 2b illustrates a fixed point design for calculating autocorrelation matrix values for a first calibration mode. For this circuit, autocorrelation matrix values R[0], R[1], and R[3] are calculated based on an input signal.

FIG. 2c illustrates a fixed point design for estimating I/Q imbalance parameters. Here, the calculated autocorrelation matrix values are inputted, and the I/Q imbalance parameters are calculated based on the autocorrelation matrix values.

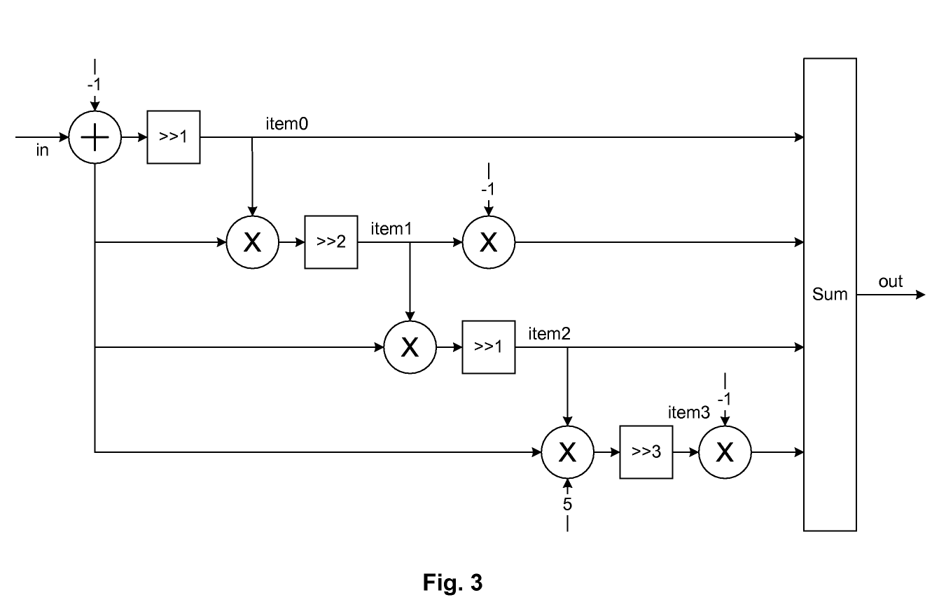

FIG. 2d illustrates a fixed point design for I/Q imbalance compensation based on the I/Q imbalance parameters. Here, the I/Q imbalance parameters are inputted along with the input signal, and the input signal is I/Q imbalance compensated based on the I/Q imbalance parameters. In performing this calculation, a sqrt_appr module for calculating a square root is used. FIG. 3 illustrates an example of an implementation for a sqrt_appr module.

For the first calibration mode, K₁ and K12 can be set to an initial value of 1; and K₂ can be set to an initial value of 0. After DC calibration (i.e. about 2*8192 samples), K₁, K₂ and K12 can be outputted at the end of every 8192 samples. The K₁, K₂ and K12 values may converge after processing a 100 to 1000 times.

Calibration Mode 2

The initial values for K₁, K₂ and K12 are based on a tuner calibration value, which can be obtained from Mode 1. After DC calibration (i.e. about 2*8192 samples), K₁, K₂ and K12 values can be outputted after every 8192 samples are processed.

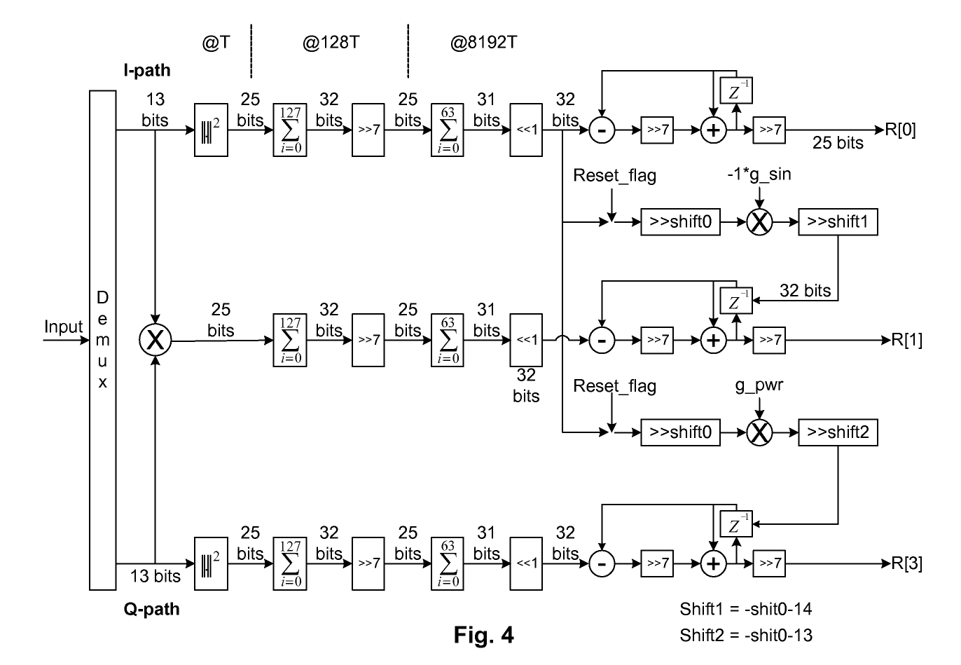

FIG. 4 illustrates a fixed point design for calculating autocorrelation matrix values for a second calibration mode. Due to the prior tuner calibration information, the initial value of R[1] and R[3] in the IIR buffer must be reset according to the calibration value. Thus, the K₁, K₂ and K12 values can converge much faster using calibration mode 2, when compared to calibration mode 1.

Time Control

The output time for the calculated K₁, K₂, and K12 values should be after the coarse time synchronization has finished. In other words, during the coarse time synchronization period, the K₁, K₂, and K12 values should be constant to improve performance.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred methods described herein but all those other and further alterations and modifications as would be apparent to those of ordinary skilled in the art.

We claim:

1. A method for calculating an I/Q imbalance compensated signal from a received signal, comprising the steps of:
removing DC from the received signal;
calculating an autocorrelation matrix of I/Q signal vector of the received signal;
estimating I/Q imbalance compensation values, K₁ and K₂, as a function of an amplitude imbalance, g, and a phase imbalance, θ; and
calculating an I/Q compensated signal as a function of the estimated K₁ and K₂.

2. The method of claim 1 wherein the autocorrelation matrix is R, where
$${R}_{{Z}^{″} {Z}^{″ T}} = {σ}_{Z}^{2} [ \begin{matrix}1 & - g sin ( θ ) \\ - g sin ( θ ) & {g}^{2}\end{matrix} ] . \qquad$$

3. The method of claim 2 wherein the autocorrelation matrix is given by R[0], R[1], and R[3].

4. The method of claim 1 wherein in a first calibration mode, K₁ and K₂ are set without prior information.

5. The method of claim 1 wherein in a second calibration mode, K₁ and K₂ are set based on prior information.

6. The method of claim 4 wherein in a second calibration mode, K₁ and K₂ are set based on prior information.

7. The method of claim 1 wherein said I/Q imbalance compensation values are
$${K}_{1} = \frac{1 + {ge}^{- j θ}}{2} and {K}_{2} = \frac{1 - {ge}^{j θ}}{2} .$$

8. The method of claim 1, wherein the method is performed in the time domain.

9. A method for calculating an I/Q imbalance compensated signal from a received signal, comprising the steps of:
removing DC from the received signal;
calculating an autocorrelation matrix of I/Q signal vector of the received signal;
estimating I/Q imbalance compensation values, K₁ and K₂, as a function of an amplitude imbalance, g, and a phase imbalance, θ; and
calculating an I/Q compensated signal as a function of the estimated K₁ and K₂;
wherein in a first calibration mode, K₁ and K₂ are set without prior information, and, in a second calibration mode, K₁ and K₂ are set based on prior information.

10. The method of claim 9 wherein the autocorrelation matrix is R, where
$${R}_{{Z}^{″} {Z}^{″ T}} = {σ}_{Z}^{2} [ \begin{matrix}1 & - g sin ( θ ) \\ - g sin ( θ ) & {g}^{2}\end{matrix} ] . \qquad$$

11. The method of claim 10 wherein the autocorrelation matrix is given by R[0], R[1], and R[3].

12. The method of claim 9 wherein said I/Q imbalance compensation values are
$${K}_{1} = \frac{1 + {ge}^{- j θ}}{2} and {K}_{2} = \frac{1 - {ge}^{j θ}}{2} .$$

13. The method of claim 9, wherein the method is performed in the time domain.

14. A method for calculating an I/Q imbalance compensated signal from a received signal, comprising the steps of:
removing DC from the received signal;
calculating an autocorrelation matrix of I/Q signal vector of the received signal;
estimating I/Q imbalance compensation values, K₁ and K₂, as a function of an amplitude imbalance, g, and a phase imbalance, θ; and
calculating an I/Q compensated signal as a function of the estimated K₁ and K₂;
wherein in a first calibration mode, K₁ and K₂ are set without prior information, and, in a second calibration mode, K₁ and K₂ are set based on prior information; and wherein said I/Q imbalance compensation values are
$${K}_{1} = \frac{1 + {ge}^{- j θ}}{2} and {K}_{2} = \frac{1 - {ge}^{j θ}}{2} .$$

15. The method of claim 14 wherein the autocorrelation matrix is R, where
$${R}_{{Z}^{″} {Z}^{″ T}} = {σ}_{Z}^{2} [ \begin{matrix}1 & - g sin ( θ ) \\ - g sin ( θ ) & {g}^{2}\end{matrix} ] .$$

16. The method of claim 15 wherein the autocorrelation matrix is given by R[0], R[1], and R[3].

17. The method of claim 14, wherein the method is performed in the time domain.
